(19) United States
(12) Patent Application Publication
(10) Pub. No.: US 2001/0027430 A1
(43) Pub. Date: Oct. 4, 2001

(54) Method of financial investment in stocks and shares or other financial entities

(75) Inventor: Massoud Sabourian, London (GB)

Correspondence Address: Thomas M. Galgano, Esq., Galgano & Burke, Suite 135, 300 Rabro Drive, Hauppauge, NY, 11788, US

(73) Assignee: Philex Plc.

(21) Appl. No.: 09/820,566

(22) Filed: Mar. 29, 2001

Related U.S. Application Data
(63) Continuation-in-part of application No. 09/556,131, filed on Apr. 20, 2000.

(30) Foreign Application Priority Data
Mar. 30, 2000 (GB) GB 0007765.1
Apr. 10, 2000 (US) US 09/556131

(51) Int. Cl. G06F 17/60

(52) U.S. Cl. 705/35

(57) ABSTRACT

A method of financial investment in stocks and shares or other financial entities, using a host website on the internet, comprising:

(a) offering, through the host website, a sum of money to any person willing to register on the website and participate;

(b) registering that person, on-line or off-line, as a participant;

(c) allocating to the registered participant that sum of money for investment;

(d) permitting the registered participant, by taking action on the said website, to issue instructions to invest that sum of money in a portfolio of said financial entities;

(e) causing that investment to take place, and monitoring the value of the portfolio thereafter;

(f) comparing the said value of the portfolio with a predetermined threshold value, and selling the portfolio if the value drops below that threshold;

(g) permitting the registered participant to terminate the investment, and then selling the portfolio and giving the registered participant at least a predetermined proportion of the profit on the original sum of money.

### FIELD OF THE INVENTION

This invention relates to an internet-based system in which participants buy and sell stocks, shares and other financial entities.

### BACKGROUND OF THE INVENTION

Internet-based commerce is rapidly gaining in popularity. On-line commercial advertising is now widespread, with many website operators competing to find buyers of advertising space on their web pages. The price at which on-line advertising space can be sold to advertisers by the operator is dependent on the frequency with which people browsing the internet visit the website, and consequently there is great competition between website operators to attract browsers of the internet (commonly known as internet traffic) to visit their sites. One way of achieving this is for the operator to offer the incentive of a chance of financial gain to those who visit the website.

### OBJECT OF THE INVENTION

The object of the invention is to provide a system which offers an incentive for browsers of the internet to visit the operator's website and thereby view advertisements placed by advertisers. The incentive offered via the present invention comprises an opportunity for financial gain for those who visit the website.

### STATEMENT OF INVENTION

According to the present invention, there is provided a method of financial investment in stocks and shares or other financial entities, using a host website, comprising (a) offering, through the host website, a sum of money to any person willing to register on the website; (b) registering that person, on-line or off-line, as a participant; (c) allocating to the registered participant that sum of money; (d) permitting the registered participant, by taking action on the said website, to issue instructions to invest that sum of money in a portfolio of said financial entities; (e) causing that investment to take place, and monitoring the value of the portfolio thereafter; (f) comparing the said portfolio with a predetermined threshold value, and selling the portfolio if the value drops below that threshold; (g) permitting the registered participant to terminate the investment, and then selling the portfolio and giving the registered participant at least a predetermined proportion of the profit on the original sum of money.

The advantage of the present invention is that the participant is attracted to the operator's website by the enticement of the chance of making money at no personal expense (apart from the cost of connecting to the internet and/or paying a subscription charge in order to participate) and with no risk of personal financial loss. The participant will view the advertisements placed on the site by advertisers, both when registering and selecting the investment portfolio, and when returning to the site to monitor the portfolio's progress. Public exposure to the advertisements would therefore be expected to be great, and consequently the operator of the website will be able to command a high level of advertising revenue.

Preferably the method includes the step of placing commercial advertisements on the host website, the advertisements being such that they are presented for viewing by the participant during the participants interaction with the website.

Preferably, in step (b) of the method, the person is registered on-line as a participant, and the advertisements are presented for viewing by the participant during that step. Preferably, advertisements are also presented for viewing during step (d) of permitting the registered participant to issue instructions on investment, and during step (g) of permitting the registered participant to terminate the investment. This thereby ensures that the advertisements are seen and cannot be overlooked by the participant during his interaction with the website.

According to the present invention, there is also provided a computer program and a computer program stored on a data carrier, both for implementing a method of financial investment as summarised above, and a computer system for connection to the internet, programmed so as to implement a method of financial investment as summarised above.

According to a second aspect of the present invention, there is provided a method of attracting internet traffic to a website, said method comprising providing, on said website, a game involving trading in virtual stocks, virtual shares or other virtual financial entities, said game comprising: (a) offering, through the host website, a sum of virtual money to any person willing to register on the website and participate; (b) registering that person as a participant; (c) allocating to the registered participant that sum of virtual money for virtual investment; (d) permitting the registered participant, by taking action on the said website, to invest that sum of virtual money and thereby form a virtual portfolio of said virtual financial entities; (e) allowing the registered participant to trade said virtual portfolio of virtual financial entities, said trading comprising buying and selling virtual financial entities at prices determined by the website operator; (f) permitting the registered participant to liquidate said virtual portfolio of virtual financial entities at any one of one or more predetermined points in time during the gameplay; and then: (g) awarding the registered participant real monetary winnings, said winnings being a function of the gain in value of the virtual portfolio managed by the participant.

Some of the advantages of this aspect of the invention are the same as those previously described in relation to the previously-described aspect of the invention. However, this aspect of the invention has additional advantages in that it can be run by the operator without his needing to find a potentially large amount of initial capital or to incur potentially large ongoing costs. Furthermore, if the participants select poorly performing portfolios of virtual financial entities, the operator is not exposed to the risk of losing money, which is possible if the website is run in accordance with the previously -described aspect of the invention.

Preferably, in step (e) of the method, the buying and selling prices of the virtual financial entities are determined as a function of the buying and selling prices of equivalent real financial entities being traded on one or more real stock markets. This has the advantage of making the gameplay more realistic, thereby attracting more participants.

More preferably, the buying and selling prices of the equivalent real financial entities are supplied to the website operator in real time using a data feed, directly or indirectly from said one or more real stock markets. This has the advantage of allowing the website to function automatically, without the need for human intervention, thereby minimising the operator's running costs and maximising his profits.

The present invention also provides a computer program and a computer program stored on a data carrier, both for implementing a method of attracting internet traffic to a website as summarised above, and a computer system for connection to the internet, programmed so as to implement a method of attracting internet traffic to a website as summarised above.

### BRIEF DESCRIPTION OF THE DRAWINGS

Embodiments of the invention will now be described, by way of example, and with reference to the drawings in which:

FIG. 1 illustrates the arrangement of a system for the implementation of a first embodiment of the invention, by which the host website operator interacts With participants and advertisers;

FIG. 2 illustrates the procedure by which participants interact with the system of FIG. 1 run by the operator,

FIG. 3 illustrates the arrangement of a system for the implementation of a second embodiment of the invention, by which the host website operator interacts with participants and advertisers; and

FIG. 4 illustrates the procedure by which participants interact with the system of FIG. 3 run by the operator.

### DETAILED DESCRIPTION OF THE PREFERRED EMBODIMENTS OF THE INVENTION

### Embodiment 1

### A Website through which Participants Invest in Real Financial Entities using Real Stockbrokers

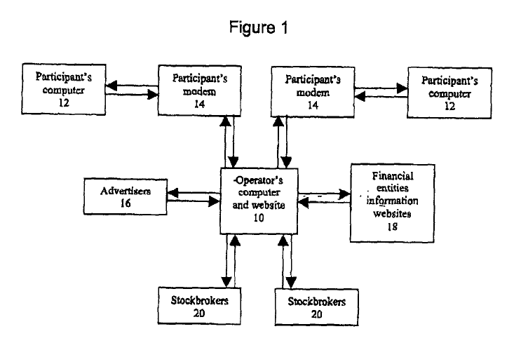

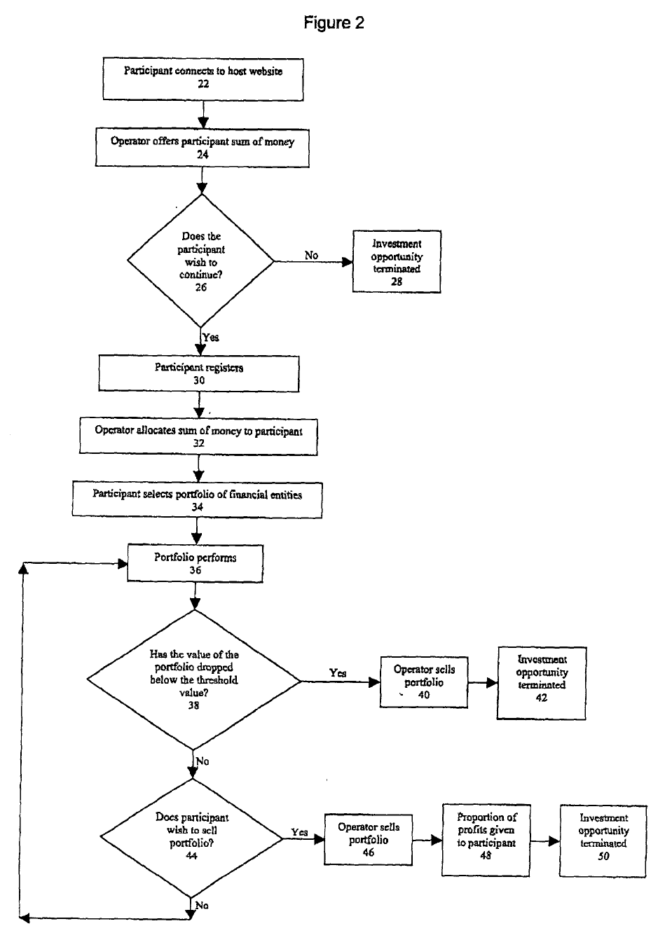

The arrangement of the system and procedure for its use, which constitute a presently preferred embodiment of the invention, will now be described with reference to FIGS. 1 and 2.

The operator of the system, hereinafter referred to as the operator, provides a host computer 10 comprising, but not limited to:

a central processing unit;

memory (both random access memory and read-only memory);

a clock;

data storage devices, e.g. hard disk drives, CD-ROM drives and magneto-optical drives;

an operating system incorporating data encryption software;

a network interface capable of enabling the computer to serve as a web server, providing a permanent connection to the internet and capable of both receiving and transmitting data.

The operator of the host computer 10 charges advertisers 16 for placing commercial advertisements on the web pages hosted by the operator. The advertisements may commonly incorporate links to the advertisers' own web pages.

The operator's website may be visited simultaneously by a plurality of people browsing the internet, each of which uses a computer 12 connected to the internet via a permanent network connection or using a modem 14. Upon connecting 22 (FIG. 2) to the operator's website for the first time, each such person, hereinafter known as the participant, is offered a sum of money 24 with which to invest, via the operator's system, in stocks, shares and other financial entitles. The participant can choose 26 whether he wishes to accept or decline this offer. If he declines, the opportunity for investment is terminated 28.

If the participant accepts the offer, he is then required to register 30 with the operator. The registration, which may be carried out on-line or off-line, comprises the participant providing personal details including his name, address and contact details, and may include responses to further marketing questions relating to his preferences as a consumer and user of the internet.

Upon registering, the participant is provided with a user identity and a password, and is allocated 32 a sum of money by the operator, which the participant may invest in a portfolio of stocks, shares or other financial entities selected 34 only by using the operator's website. The participant can access information about potential investments by following links from the host website to other sites 18 offering investment information. The operator may charge companies for the provision of links to their information sites from the host site.

After the portfolio has been selected, the operator instructs stockbrokers 20 (FIG. 1) to invest the sum of money allocated to the participant in the selected portfolio. More than one stock-broking firm may be involved in this operation. The instructions to stockbrokers 20 are preferably issued via the internet, using secure connections, and the payment from the operator to the stockbrokers is preferably effected electronically (e.g. Via e-commerce over the internet) after the stockbrokers have executed the transaction. The portfolio is then allowed to perform 36 and its value is monitored by the operator independently of the participant.

If, at any time, the value of the portfolio drops 38 below a predetermined threshold value, the operator instructs the stockbrokers 20 to sell 40 the portfolio, and the participants investment opportunity is terminated 42. The predetermined threshold value is chosen by the operator and is made known to the participant from the outset. It may typically be 80% of the original value of the portfolio, but could take any value chosen by the operator, e.g. from 60% to 90%.

The participant is able to monitor the performance of his chosen portfolio at any time by connecting again to the website and supplying his user identity and password. Provided the portfolio has not been sold by the operator on the grounds of its value having fallen below the threshold, the participant is given the opportunity to sell the portfolio. If he elects to do so, the operator instructs the stockbrokers 20 to carry out this procedure, a predetermined proportion of, or the total value of, the profits from the sale are given 48 to the participant, and the investment opportunity is terminated 50. If the participant does not wish to sell the portfolio, it is allowed to continue to perform.

During the course of his interaction with the operator's website, the participant is made to view the advertisements placed by the advertisers 16, which are placed prominently on the screen display. The advertisements may be displayed at any stage, and preferably at all stages, during the procedure depicted in FIG. 2, for example, during registration, during the selection of the portfolio, or during the stage in which the participant is given the opportunity to sell the portfolio.

The advertisements could be arranged so that the participant is made to Wait for a sequence of advertisements to complete before being allowed to continue to the next stage of the procedure.

The investment procedure is provided, via the operator's website, by a computer program stored on the data storage devices of the host computer 10. In addition to governing the transmitting and receiving of data to and from each participant when connected to the website, the program also incorporates a multitasking database on which the participants' personal details and portfolio selections are stored, along with means for automatically monitoring the performance of the portfolios and taking appropriate action in accordance with the procedures described in the figures. The program is also made to record the number of occasions on which the host website is visited, and this information may then be used by the operator to convince advertisers of the value of buying advertising on the website. The construction of such a computer program will be known to those skilled in the art, for example, software engineers.

The financial payments, to the operator from the advertisers, and from the operator to the participants, are preferably effected electronically by credit card or charge card transactions, e.g. over the internet, using secure connections, as is well known in e-commerce.

An alternative embodiment of this invention allows the participant to modify the composition of the portfolio during the course of its life. Such a modification may incur a charge, the value of which would be deducted from the value of the portfolio.

### Embodiment 2

### A Website Providing a Game in which Participants Invest in Virtual Financial Entities in a Virtual Trading Environment

An alternative embodiment of the present invention involves running the website in a similar manner to that described in Embodiment 1, but instead of trading in real financial entities via real stockbrokers, trading of portfolios of virtual financial entities is performed in a virtual trading environment This virtual trading environment, also referred to herein as a ‘virtual stock market’ is characterised by, inter alia, the following features:

All trading takes place within a computer simulation of one or more stock markets.

Real stocks, shares and other financial entities are not traded, and real stockbrokers are not used to execute transactions. Instead the Investment portfolios exist only as virtual entities within the computer system run by the website operator, and the virtual trading occurs within this computer system.

The buying and selling prices of the financial entities are able to be controlled by the website operator. These prices, which can vary with time, are determined by the operator. These prices would usually (but not necessarily) be determined as a function of the prices of equivalent financial entities being traded on one or more real stock markets.

This embodiment has several advantages over the embodiment described previously, some of which are that:

The computer system and website can be fully automated.

There is no need to use external stockbrokers, and consequently there is no need to pay out any commission to third parties when trading.

The operator does not need to have access to a potentially large amount of capital with which to finance the participants' trading.

The operator will not incur a financial loss as a consequence of the participants selecting poorly-performing portfolios.

Capital gains tax would not need to be paid on the income generated by successfully-performing portfolios

Participants participate in the game for a predetermined period of time from the point of registration, and the operator does not terminate a participant's participation in the game if his portfolio performs badly. Instead, the participant is allowed to continue participating in the game, and this can thereby lead to exposure of the advertisements by participants for a longer period of time than in the embodiment described previously.

This embodiment of the invention, rather than functioning as a direct investment opportunity for the participants, takes the form of a game. Each participant is initially allocated a predetermined sum of virtual money with which to form a portfolio of virtual financial entities, which are subsequently traded in the virtual stock market provided by the operator. Participants who trade sufficiently successfully are awarded a dividend by the website operator. This dividend, which is a real monetary payment awarded to the successful participant, is proportional to the amount by which the value of the his virtual portfolio has increased. The monetary payment to the successful participant is preferably effected automatically by electronic means, such as an automatic bank transfer, although a cheque might alternatively be dispatched. The website operator publishes the rules of the game on the website or by some other means, so that the participants are made aware of how the prizes are determined.

Because the website operator does not need to finance any real investments or pay stockbrokers' commission, the operator is able to run this embodiment of the invention without needing to find a potentially large amount of initial capital or to incur potentially large ongoing costs. Furthermore, if the participants select poorly-performing portfolios of virtual financial entities, the operator is not exposed to the risk of losing money, which is possible if the website is run in accordance with Embodiment 1 of this invention.

It will be appreciated that running the virtual stock market does not enable the website operator to benefit from making money when participants invest in well-performing financial entitles. Further to this, the operator is obliged to pay out dividends to successful participants. To be profitable, the website operator therefore has to generate income from other sources, some of which are:

advertising revenue from third party advertisers who pay to place advertisements within the operator's website

subscription fees paid by the participants in order to play the game

As described in Embodiment 1 of this invention, third party advertisers may pay the website operator to display advertisements throughout the website, and participants may be obliged to view advertisements during their interaction with the website.

As also described in Embodiment 1, participants would be required to register with the operator in order to participate. In addition to supplying a name and contact details, the registration process may require the participant to respond to marketing related questions.

In addition, particularly in this embodiment of the invention, participants may be required to pay a subscription fee in order to participate. This is necessary to cover the operator's costs, to pay out prizes to winners, and to make a profit for the operator. It is conceivable that the operator may not need to charge participants subscription fees if the website is sufficiently popular such that the operator can command sufficient revenue from hosting advertisements on the website. The website may be configured such that the participant has to pay a one-off subscription fee prior to commencing trading, or alternatively the participant may have to renew his subscription with the operator by paying subscription renewal fees periodically, such as monthly, quarterly or annually.

Even if the operator does not require the payment of a subscription fee in order for the participant to take part, the participant would still be required to register.

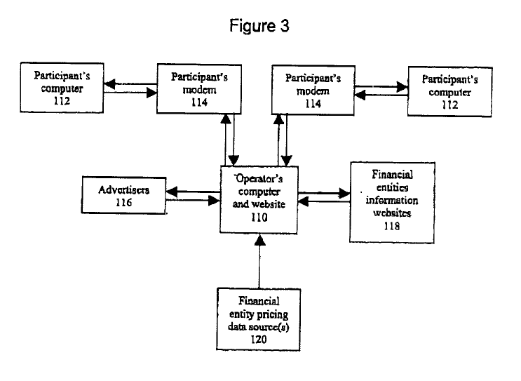

As shown in FIG. 3, the network architecture used in this embodiment of the invention is broadly the same as that of the Embodiment 1. Particpants' computers 112 are linked via modems 114 to the operators computer and website 110. The operator's website is also linked to advertisers' websites 116 and websites providing information about financial entities 118. However, in place of the stockbrokers 20 of Embodiment 1, in this embodiment the operator's computer and website 110 are supplied with financial entity pricing data from one or more data sources 120. This pricing data is then used by the website operator to determine the buying and selling prices of the financial entities being traded in the virtual stock market. This data source may be human or automated: in one alternative form of this embodiment, the pricing data is simply decided by a person, who may choose to base the buying and selling prices of the virtual financial entities on the prices of equivalent real financial entities being traded in one or more real stock markets around the world.

In the preferred form of this embodiment of the invention, pricing data is automatically taken from one or more real stock markets around the world. The virtual financial entities traded in the virtual stock market of this particular embodiment are virtual equivalents of real financial entities being traded on the real stock markets. Each virtual financial entity mirrors a distinct real financial entity, and the pricing data taken from the real stock markets reflect the price at which the real counterpart of each virtual financial entity is being bought and sold. It is likely (but by no means essential) that the virtual financial entities will have the same names as their real counterparts. If the operator desires, the names of the virtual financial entities can differ from their real counterparts. The operator is able to decide which financial entities are mirrored by the virtual financial entities, and the operator is also able to determine the range of virtual financial entities from which the participant can select his portfolio and in which he can subsequently trade. These restrictions, and others imposed by the operator, are described in further detail below.

In this embodiment, to enable the virtual stock market to function automatically without the need for human intervention, the operator's computer and website are interfaced with automated data sources 120 associated with the real stock markets. These data sources may originate directly from the stock markets' own computer systems, or from third parties such as Reuters. These data sources thereby provide the website operator with the pricing data representative of the prices for which the real financial entities are being traded. This data may be supplied direct from the real stock markets in real time, or following a pre-determined time delay. Using an automated real time data feed from real stock markets gives the advantage that the gameplay is a realistic simulation of real trading, with the prices of the virtual financial entities varying in parallel with their real counterparts, and responding to factors in the real world which affect their prices such as elections and periods of political instability, natural disasters and shortages in raw materials, change in consumer preferences, and corporate mergers, acquisitions and changes in personnel. Because of this realistic gameplay, large numbers of people will be expected to be attracted to the website and public exposure to the advertisements will be expected to be great.

### Determination of the Buying and Selling Prices of Virtual Financial Entities

For a given virtual financial entity, its buying price is greater than its selling price, and the difference is known as the ‘bid-ask spread’, or more usually, just as the spread. The spread is a pre-determined fraction a of a characteristic price P of one unit of any given virtual financial entity. A ‘unit ’ is, for example, a single share in a given company. Each virtual financial entity being traded has its own characteristic price P. In the preferred form of this embodiment of the invention, for each virtual financial entity, its characteristic price P is automatically evaluated from the pricing data taken from the real stock markets. Commonly, for example, the characteristic price P is obtained by calculating the arithmetical mean of the buying and selling prices of the equivalent real financial entity being traded on a real stock market.

The buying price P_{b} of one unit of the given financial entity is determined by the relation

P_{b}=P(1+a/2)

whereas the selling price Pₛ of a unit of the same financial entity is given by

Pₛ=P(1−a/2)

The difference between the buying and selling prices of a unit of the financial entity is therefore equal to Pa.

The value of the fraction α is determined by the operator such that the virtual portfolios held by most participants do not increase in value enough to warrant paying out dividend payments.

### Cash in Hand

If a participant does not invest all the virtual money he has been allocated in financial entities, then any uninvested money is known as ‘cash in hand’. The operator may allow cash in hand to accrue interest. If so, then this is made known to the participant from the outset.

### Long Cash Balance

At any instant, each participant's ‘long cash balance’ is given by the sum of the participant's cash in hand together with the combined selling prices Pₛ of all the virtual financial entities owned by that participant The long cash balance is therefore the net worth of the participant's virtual portfolio (which could be released by liquidation of the virtual assets held therein) plus all the participant's cash in hand.

### Shorting of Stocks and the Short Cash Balance

The operator may allow participants to short stocks, and may impose an upper limit, known as the ‘short cash balance’, to the leverage allowed. This upper limit is usually fixed by the operator as being a predetermined fraction of the short cash balance. Participants are of course free to short less than the maximum allowed.

### Trading Restrictions Imposed by the Website Operator

The operator is able to impose restrictions on the composition of individual participants' virtual portfolios. Examples of such restrictions are as follows:

Restrictions on the minimum and maximum number of distinct financial entities held in the virtual portfolio—e.g. the participants virtual portfolio must contain shares in no fewer than five and no more than twenty distinct companies,

Restrictions on the total percentage of the virtual portfolio allocated to a particular industry or market sector—e.g. a maximum of 20% of the portfolio may be allocated to shares in pharmaceutical companies.

Restrictions on the total percentage of the portfolio that can comprise a single financial entity—e.g. no more than 20% of the portfolio can comprise shares in one particular company.

Restrictions in the time before a participant may liquidate his virtual gains, and in the time thereafter when liquidation is permitted. This means that each participant must wait for a predetermined period of time after initially registering to participate before he is able to liquidate his gains. After this so-called ‘cashing out’ period (which may be monthly or quarterly, for example) has elapsed, the participant may elect to liquidate his gains. If the participant decides not to do so at this stage, then he is made to wait until further predetermined periods of time have elapsed before being given further opportunities to do so. For example, if the cashing out periods are quarterly, then a participant who registered to participate on Jan, 1, 2001 would be given his first opportunity to liquidate his gains on Apr. 1, 2001. If he decides not to do so at this stage, but to continue trading this portfolio, then his next opportunity would be on Jul. 1, 2001, and thereafter on Oct. 1, 2001 and Jan. 1, 2002. The operator may decide to make the initial cashing out period a different length of time to the subsequent cashing out periods. For example, after commencing participation the period may be three months, but then subsequent cashing out periods may be monthly. Imposing predetermined cashing out periods enables the operator to ensure that many participants do not all liquidate their gains on days when the market has performed exceptionally well.

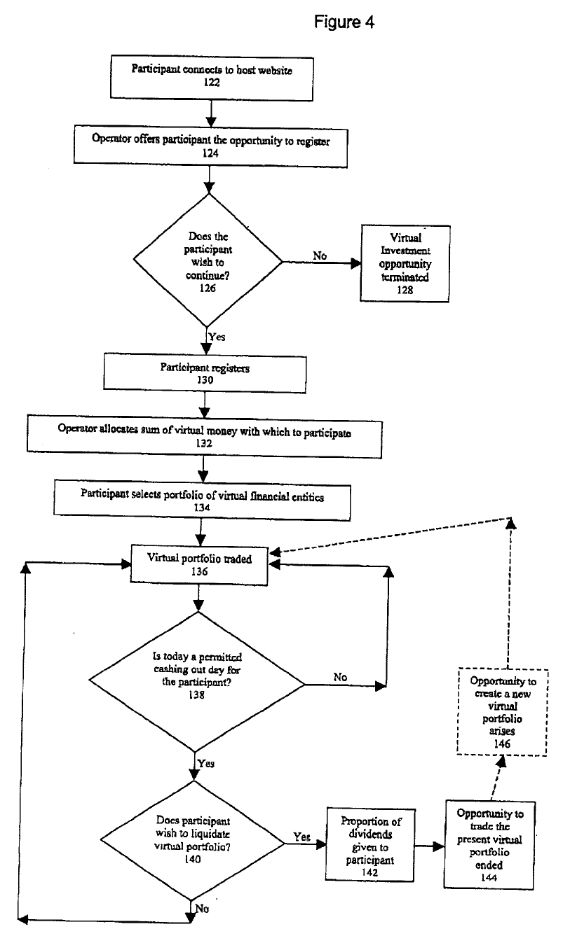

### Format of the Gameplay (with reference to FIG. 4)

After connecting 122 to the operator's website, each participant is given 124 the opportunity to register. If the participant decides 126 they do not wish to register, their opportunity to participate further is terminated 128. If the participant does decide to register, then, on registering 130 (which involves supplying personal details which are stored on the operator's computer system) each participant is allocated 132 a pre-determined sum of virtual money with which he can form 134 his virtual portfolio. The initial portfolio is formed by the participant choosing from the financial entities available, within any restrictions imposed by the operator as described above.

This virtual portfolio can then be traded 136. The participant is free (within the restrictions imposed by the operator) to select which of his assets he wishes to sell at the current selling price, and can buy financial entities (priced at the current buying price) to add to his portfolio. As described above, the buying and selling prices are preferably determined automatically using on or more real time pricing data source as described previously.

The participant may trade for as long a duration as he wishes. There is no imposed timeframe to the game, save for the predetermined cashing out periods as described previously. Participants do not all have to begin trading at a given time and cease trading by a given time.

If 138 the date on which the participant interacts with the operator's website is one of the predetermined days on which that specific participant is permitted to cash out, then he is given the opportunity 140 to liquidate his virtual portfolio. If the portfolio has increased in value, then a predetermined proportion of the dividends are given 142 to the participant as winnings. These winnings are given to the participant in the form of real money, and the transfer of the winnings are preferably effected electronically by the operators computer system, using a means of automatic transfer. The participant's opportunity to trade his present virtual portfolio on the virtual stock market is thereby ended 144.

However, if 138 the date on which the participant interacts with the operators website is not one of the predetermined days on which that specific participant is permitted to cash out, then he is not given the opportunity to cash out and instead trading 136 of his virtual portfolio continues.

It is important to emphasise that the length of gameplay is not limited (save for predetermined cashing out periods as discussed), and that the winnings awarded to the successful participant is a function of the performance of their virtual portfolio. The gameplay does not restrict the participants to begin trading on a predetermined start date, and does not restrict them to cease trading on a fixed end date. The winnings do not take the form of simple prizes (e.g. 1^{st}, 2^{nd} and 3^{rd} prizes) for the most successful traders. Instead, any participant for whom his virtual portfolio has performed sufficiently well will be rewarded with a real monetary prize which is a function of the increase in value of his virtual portfolio of financial entitles.

Participants register (and possibly, at the discretion of the operator, pay a subscription) to play the game for a predetermined period of time such as one year. Participants who elect to cash out part way through this predetermined period of gameplay are given the opportunity 146 to recommence trading with a newly selected portfolio of virtual financial entities for the remainder of the predetermined period of gameplay. If the participant elects to proceed with a newly-selected portfolio then trading 136 of the new virtual portfolio ensues.

1. A method of financial investment in stocks and shares or other financial entities, using a host website on the internet, comprising:
(a) offering, through the host website, a sum of money to any person willing to register on the website and participate,
(b) registering that person, on-line or off-line, as a participant;
(c) allocating to the registered participant that sum of money for investment;
(d) permitting the registered participant, by taking action on the said website, to issue instructions to invest that sum of money in a portfolio of said financial entities;
(e) causing that investment to take place, and monitoring the value of the portfolio thereafter,
(f) comparing the said value of the portfolio with a predetermined threshold value, and selling the portfolio if the value drops below that threshold;
(g) permitting the registered participant to terminate the investment, and then selling the portfolio and giving the registered participant at least a predetermined proportion of the profit on the original sum of money.

2. A method according to claim 1, including the step of placing commercial advertisements on the host website, the advertisements being such that they are presented for viewing by the participant during the participants interaction with the website.

3. A method according to claim 2, in which, in step (b), the person is registered on-line as a participant, and the advertisements are presented for viewing by the participant during that step.

4. A method according to claim 2, in which the advertisements are presented for viewing by the participant during step (d) of permitting the registered participant to issue instructions on investment.

5. A method according to claim 2, in which the advertisements are presented for viewing by the participant during step (g) of permitting the registered participant to terminate the investment.

6. A method according to claim 1 in which the step (e) of causing the investment to take place is conducted on the internet using one or more website linked to the host website.

7. A method according to claim 1 in which, in step (d), the registered participant views information about potential investments on the basis of information obtained from one or more websites linked to the host website.

8. A method according to claim 1, in which the said predetermined value is a predetermined percentage of the original sum of money.

9. A computer program for implementing a method of financial investment in stocks and shares or other financial entitles, using a host website on the internet, comprising:
(a) offering, through the host website, a sum of money to any person willing to register on the website and participate;
(b) registering that person, on-line or off-line, as a participant;
(c) allocating to the registered participant that sum of money for investment;
(d) permitting the registered participant, by taking action on the said website, to issue instructions to invest that sum of money in a portfolio of said financial entities;
(e) causing that investment to take place, and monitoring the value of the portfolio thereafter;
(f) comparing the said value of the portfolio with a predetermined threshold value, and selling the portfolio if the value drops below that threshold;
(g) permitting the registered participant to terminate the investment, and then selling the portfolio and giving the registered participant at least a predetermined proportion of the profit on the original sum of money.

10. A computer program stored on a data carrier, for implementing a method of financial investment in stocks and shares or other financial entities using a host website on the internet, comprising:
a) offering, through the host website, a sum of money to any person willing to register on the website and participate;
b) registering that person, on-line or off-line, as a participant;
c) allocating to the registered participant that sum of money for investment;
d) permitting the registered participant, by taking action on the said website, to issue instructions to invest that sum of money in a portfolio of said financial entities;
e) causing that investment to take place, and monitoring the value of the portfolio thereafter;
f) comparing the said value of the portfolio with a predetermined threshold value, and selling the portfolio if the value drops below that threshold;
g) permitting the registered participant to terminate the investment, and then selling the portfolio and giving the registered participant at least a predetermined proportion of the profit on the original sum of money.

11. A computer system for connection to the internet, programmed so as to implement a method of financial investment in stocks and shares, or other financial entities, using a host website on the internet, comprising:
a) offering, through the host website, a sum of money to any person willing to register on the website and participate;
b) registering that person, on-line or off-line, as a participant;
c) allocating to the registered participant that sum of money for investment;
d) permitting the registered participant, by taking action on the said website, to issue instructions to invest that sum of money in a portfolio of said financial entities;
a) causing that investment to take place, and monitoring the value of the portfolio thereafter;
e) causing that investment to take place, and monitoring the value of the portfolio thereafter;
f) comparing the said value of the portfolio with a predetermined threshold value, and selling the portfolio if the value drops below that threshold;
g) permitting the registered participant to terminate the investment, and then selling the portfolio and giving the registered participant at least a predetermined proportion of the profit on the original sum of money.

12. A method of attracting internet traffic to a website, said method comprising providing, on said website, a game involving trading in virtual stocks, virtual shares or other virtual financial entities, said game comprising:
a) offering, through the host website, a sum of virtual money to any person willing to register on the website and participate;
b) registering that person as a participant;
c) allocating to the registered participant that sum of virtual money for virtual investment;
d) permitting the registered participant, by taking action on the said website, to invest that sum of virtual money and thereby form a virtual portfolio of said virtual financial entities;
e) allowing the registered participant to trade said virtual portfolio of virtual financial entities, said trading comprising buying and selling virtual financial entities at prices determined by the website operator;
f) permitting the registered participant to liquidate said virtual portfolio of virtual financial entities at a predetermined point in time during the gameplay; and then:
g) awarding the registered participant real monetary winnings, said winnings being a function of the gain in value of the virtual portfolio managed by the participant.

13. A method according to claim 12, including the step of placing commercial advertisements on the host website, the advertisements being such that they are presented for viewing by the participant during the participant's interaction with the website.

14. A method according to claim 12, in which the step (e) of virtual trading, the buying and selling prices of the virtual financial entities are determined as a function of the buying and selling prices of equivalent real financial entities being traded on one or more real stock markets.

15. A method according to claim 14, in which the buying and selling prices of the equivalent real financial entities are supplied to the website operator in real time using a data feed, directly or indirectly from said one or more real stock markets.

16. A method according to any of claims 12 to 15, in which the operator's website imposes a minimum number of distinct financial entities that the participant may hold in the virtual portfolio.

17. A method according to any of claims 12 to 15, in which the operator's website imposes a maximum number of distinct financial entities that the participant may hold in the virtual portfolio.

18. A method according to any of claims 12 to 15, in which the operator's website restricts the total percentage of the participants virtual portfolio allocated to a particular industry or market sector.

19. A method according to any of claims 12 to 15, in which the operator's website restricts the total percentage of the participant's virtual portfolio that can comprise a single financial entity.

20. A computer program for implementing a method of attracting internet traffic to a website, said method comprising providing, on said website, a game involving trading in virtual stocks, virtual shares or other virtual financial entities, said game comprising:
a) offering, through the host website, a sum of virtual money to any person willing to register on the website and participate;
b) registering that person as a participant;
c) allocating to the registered participant that sum of virtual money for virtual investment;
d) permitting the registered participant, by taking action on the said website, to invest that sum of virtual money and thereby form a virtual portfolio of said virtual financial entities;
(e) allowing the registered participant to trade said virtual portfolio of virtual financial entities, said trading comprising buying and selling virtual financial entities at prices determined by the website operator;
f) permitting the registered participant to liquidate said virtual portfolio of virtual financial entities at any one of one or more predetermined points in time during the gameplay; and then:
g) awarding the registered participant real monetary winnings, said winnings being a function of the gain in value of the virtual portfolio managed by the participant.

21. A computer program stored on a data carrier, for implementing a method of attracting internet traffic to a website, said method comprising providing, on said website, a game involving trading in virtual stocks, virtual shares or other virtual financial entities, said game comprising:
a) offering, through the host website, a sum of virtual money to any person willing to register on the website and participate;
b) registering that person as a participant;
c) allocating to the registered participant that sum of virtual money for virtual investment;
d) permitting the registered participant, by taking action on the said website, to invest that sum of virtual money and thereby form a virtual portfolio of said virtual financial entities;
e) allowing the registered participant to trade said virtual portfolio of virtual financial entities, said trading comprising buying and selling virtual financial entities at prices determined by the website operator;
f) permitting the registered participant to liquidate said virtual portfolio of virtual financial entities at any one df one or more predetermined points in time during the gameplay; and then:
g) awarding the registered participant real monetary winnings, said winnings being a function of the gain in value of the virtual portfolio managed by the participant.

22. A computer system for connection to the internet, programmed so as to implement a method of attracting internet traffic to a website, said method comprising providing, on said website, a game involving trading in virtual stocks, virtual shares or other virtual financial entities, said game comprising:
a) offering, through the host website, a sum of virtual money to any person willing to register on the website and participate:
b) registering that person as a participant;
c) allocating to the registered participant that sum of virtual money for virtual investment;
d) permitting the registered participant, by taking action on the said website, to invest that sum of virtual money and thereby form a virtual portfolio of said virtual financial entities;
e) allowing the registered participant to trade said virtual portfolio of virtual financial entities, said trading comprising buying and selling virtual financial entities at prices determined by the website operator;
f) permitting the registered participant to liquidate said virtual portfolio of virtual financial entities at any one of one or more predetermined points in time during the gameplay; and then:
g) awarding the registered participant real monetary winnings, said winnings being a function of the gain in value of the virtual portfolio managed by the participant.
